(19) United States
(12) Patent Application Publication
(10) Pub. No.: US 2020/0047150 A1
(43) Pub. Date: Feb. 13, 2020

(54) MESOPOROUS ALUMINA/HEMATITE COMPOSITE NANOFIBERS FOR HEAVY METAL REMOVAL

(71) Applicants: David Michael CWIERTNY, Iowa City, IA (US); THE REGENTS OF THE UNIVERSITY OF CALIFORNIA, Oakland, CA (US)

(72) Inventors: David Michael CWIERTNY, Iowa City, IA (US); Nosang V. MYUNG, Riverside, CA (US); Michael J. NALBANDIAN, Riverside, CA (US)

(73) Assignee: THE REGENTS OF THE UNIVERSITY OF CALIFORNIA, Oakland, CA (US)

(21) Appl. No.: 16/462,755

(22) PCT Filed: Nov. 22, 2017
(86) PCT No.: PCT/US17/62953

§ 371 Date: May 21, 2019

Related U.S. Application Data
(60) Provisional application No. 62/425,580, filed on Nov. 22, 2016.

(51) Int. Cl. B01J 20/08; C02F 1/28; B01J 20/28; B01J 20/32

(52) U.S. Cl. CPC B01J 20/08; C02F 1/288; B01J 20/28007; B01J 20/28023; C02F 2101/22; B01J 20/28071; B01J 20/28083; B01J 20/3236; B01J 20/3204; B01J 20/28059

(57) ABSTRACT

A method is disclosed of synthesizing θ-alumina/hematite (θ-Al₂O₃/Fe₂O₃) composite nanofibers for removing heavy metals from a water source. The method includes preparing a polymer solution, the polymer solution comprising an iron precursor, acetic acid and a polymer; adding a select amount of an aluminum precursor to the polymer solution; and electrospinning the polymer solution and the select amount of the aluminum precursor to form the θ-Al₂O₃/Fe₂O₃ composite nanofibers.

### CROSS-REFERENCES TO RELATED APPLICATIONS

This application claims priority to U.S. Provisional Application No. 62/425,580 filed on Nov. 22, 2016, the entire content of which is incorporated herein by reference.

### FIELD OF THE INVENTION

The present disclosure relates to a method and system for synthesizing θ-Al₂O₃/Fe₂O₃ composite nanofibers and optimizing their adsorption performance for the removal of heavy metals, for example, chromium (Cr), from, for example, a water source.

### BACKGROUND OF THE INVENTION

Heavy metals, elements used heavily in industry that known for their high toxicity toward biological life, have continued to be a ubiquitous water supply dilemma due to their discovery in groundwater sources. While their emergence and adverse effects have been known and understood for a long time, exposure to these contaminants continues around the world and increasingly in developing countries. For example, chromium (Cr) is prevalent in many different metal industry processes, such as electroplating, leather tanning, wood preservations, and chemical industries. However, the emergence of Cr in the environment can be caused by leakage, poor storage, or unsafe disposal practices of industrial wastes.

Many treatment techniques have been utilized to remove heavy metals from water sources, such as chemical precipitation, ion exchange, membrane filtration, and adsorption. Of the various treatment methods, adsorption, a simple physical process where pollutants attach themselves onto surface functional groups of a highly porous substrate, has garnered the most attention because it offers benefits outside of great heavy metal removal efficiency. In addition to the lower demand of energy and excess chemicals compared to other treatment techniques, adsorption also provides versatility in design and operation, as well as feasible material regeneration via desorption.

Metal oxide substrates, such as iron oxide (Fe₂O₃) and alumina (Al₂O₃), are the most popular materials used in adsorption due to their high surface area and great adsorption activity. Compared to other known adsorbents, such as zeolites, graphene, and activated carbon, metal oxides yield greater adsorption performance, as well as offer other special benefits. Firstly, the depletion of carbonaceous sources has led to the increase in cost of activated carbon, whereas Fe₂O₃ is relatively inexpensive and easily synthesizable due to the abundance of iron on Earth. The emergence of carbon nanotube and graphene usage has posed a risk to accidental discharge into the environment and harm to humans, whereas Fe₂O₃, which is naturally occurring in aqueous environments, is non-toxic to humans. Lastly, zeolites and other microporous materials that are commonly associated with adsorption/ion exchange columns are easily prone to fouling and usually treated with iron for enhanced performance.

Through the advancement of nanotechnology, Fe₂O₃ nanomaterials, such as nanoparticles, nanorods, nanoplates, and nanoflowers, have found homes in a large array of different application, with sensing, catalysis and water purification just being a few examples. While simple synthesis of Fe₂O₃ is readily accessible, manipulation of nanotechnology (via size, shape, composition, etc.) is increasingly more prevalent in order to take advantage of all the nano-scale properties these materials can offer. As previously stated, Fe₂O₃ nanomaterials have garnered attention for their heavy metal removal capacity, yet there is large room for improvement, especially in terms of pollutant removal capabilities and kinetics.

For example, modifications of Fe₂O₃ nanoparticles, most notably nanocomposites with other metal oxide species, are becoming more common in order to utilize their recognized adsorption properties and, through nanoscale synthesis, enhance their performance further than their unmodified counterparts can possibly achieve. Nanofibers synthesized via electrospinning are an emergent nanomaterial used in many different applications, but has seen its benefits in water treatment because of its material property control via electrospinning process tunability, high surface-area-to-volume ratio through dimension manipulation, robustness and stability under high pressure drops and volumetric flux, and feasible membrane integration for nanomaterial immobilization. Additionally, nanofibers can be easily created as composites by mixing the metal oxide precursors in the sol-gel solution prior to the electrospinning process.

There have been several reports on Fe₂O₃-containing nanocomposites for different applications, including magnetics, artificial photosynthesis, and water treatment. Synthesis methods include electrospinning, electrodeposition, sol-gel method, and hydrothermal method. The inclusion of the metal additive shows an increase in performance for each respective purpose, but more specifically for water treatment, the metal additives enhanced adsorption capabilities of various heavy metals (for example, As, Cr, Cd, Pb, Cu, Co). Although, research surrounding composite Fe₂O₃ nanoparticles is available, there is very limited work on nanocomposites towards water treatment, let alone work from electrospun composite nanofibers, which have great potential for treatment integration. In addition, while there are a few reports on electrospun composite Fe₂O₃ nanofibers towards heavy metal adsorption, they do not offer extensive property and performance studies, alongside comparisons with commercial materials. Additionally, the reported composite nanofibers are also relatively large (for example, 200 nm to 500 nm), indicating necessary improvement to maximize surface area-to-volume ratio.

### SUMMARY OF THE INVENTION

In consideration of the above issues, θ-Al₂O₃/Fe₂O₃ composite nanofibers were synthesized and optimized for their adsorption performance for the removal of heavy metals, for example, chromium (Cr). In accordance with an exemplary embodiment, the composite nanofibers were synthesized through the electrospinning process, as synthesis parameters were manipulated to control the nanofiber's dimensional and morphological properties. Synthesized nanofibers were characterized via various techniques to first relate observed changes in nanofiber properties to specific adjustments in the electrospinning procedure. In accordance with an exemplary embodiment, the composite nanofibers were run through different adsorption isotherm and kinetic experiments to analyze their adsorption performance towards chromate (CrO₄²⁻), the toxic anions of Cr commonly found in aqueous environments. In accordance with an exemplary embodiment, based on their adsorption capabilities, the structural modifications critical to optimizing treatment efficiency were identified.

A method is disclosed of synthesizing θ-alumina/hematite (θ-Al₂O₃/Fe₂O₃) composite nanofibers, the method comprising: preparing a polymer solution, the polymer solution comprising an iron precursor, acetic acid and a polymer; adding a select amount of an aluminum precursor to the polymer solution; and electrospinning the polymer solution and the select amount of the aluminum precursor to form the θ-Al₂O₃/Fe₂O₃ composite nanofibers.

A method is disclosed of removing heavy metals from water, the method comprising: exposing a water source having at least one heavy metals to θ-Al₂O₃/Fe₂O₃ composite nanofibers.

A system is disclosed for removing heavy metals from a water source, the system comprising: θ-Al₂O₃/Fe₂O₃ composite nanofibers.

It is to be understood that both the foregoing general description and the following detailed description are exemplary and explanatory and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1A is a chart illustrating average diameter as a function Al content for the θ-Al₂O₃/Fe₂O₃ nanofibers in accordance with an exemplar embodiment.

FIGS. 1B-1D are corresponding scanning electron microscope (SEM) images of B) 0, C) 10, D) 30, and E) 50 at. % Al/Fe.

FIG. 2 illustrates x-ray crystallography (XRD) patterns of the θ-Al₂O₃/Fe₂O₃ nanofibers at different Al/Fe ratios in accordance with an exemplary embodiment.

FIG. 3 is a chart illustrating adsorption of CrO₄²⁻ as a function of time of θ-Al₂O₃/Fe₂O₃ composite nanofibers in accordance with an exemplary embodiment.

FIG. 4 is a chart illustrating CrO₄²⁻ adsorption isotherm of θ-Al₂O₃/Fe₂O₃ nanofibers in accordance with an exemplary embodiment.

FIG. 5 is a chart illustrating maximum adsorption capacity of θ-Al₂O₃/Fe₂O₃ nanofibers as a function of A) Al/Fe ratio and B) Al content in accordance with an exemplary embodiment.

FIGS. 6A-6D illustrate energy-dispersive X-ray spectroscopy (EDX) spectra of the A) 0, B) 10, and C) 30, and D) 50 at. % θ-Al₂O₃—Fe₂O₃ nanofibers in accordance with an exemplary embodiment.

FIG. 7 illustrates XRD pattern of the sol-gel synthesized boehmite (AlOOH) and annealed alumina (Al₂O₃) nanopowders in accordance with an exemplary embodiment.

FIG. 8 illustrate XRD patterns of 32 at. % Al₂O₃/Fe₂O₃ nanofibers at different annealing temperatures in accordance with an exemplary embodiment.

FIG. 9 is a chart illustrating average grain size as a function of Al/Fe ratio of the θ-Al₂O₃/Fe₂O₃ nanofiber diameter in accordance with an exemplary embodiment.

FIG. 10 is a chart illustrating zeta potential of θ-Al₂O₃/Fe₂O₃ nanofibers at different Al content levels in accordance with an exemplary embodiment.

FIG. 11 is a chart illustrating specific surface area of θ-Al₂O₃/Fe₂O₃ nanofibers as a function of Al/Fe ratio in accordance with an exemplary embodiment.

FIGS. 12A-12B are charts illustrating pseudo-second-order adsorption kinetic fit (FIG. 12A) and initial adsorption rate (FIG. 12B) as a function of Al/Fe ratio of θ-Al₂O₃/Fe₂O₃ nanofibers.

FIG. 13 is a chart illustrating specific surface area-normalized CrO₄²⁻ adsorption isotherm of θ-Al₂O₃/Fe₂O₃ nanofibers.

FIGS. 14A and 14B are charts illustrating A) Equilibrium and B) specific surface area-normalized CrO₄²⁻ adsorption isotherm of commercially available Fe₂O₃ nanoparticles, unmodified Fe₂O₃ nanofibers, 32 at. % Al/Fe Al₂O₃/Fe₂O₃ composite nanofibers, and Al₂O₃ nanopowders.

### DETAILED DESCRIPTION

Reference will now be made in detail to the present preferred embodiments of the invention, examples of which are illustrated in the accompanying drawings. Wherever possible, the same reference numbers are used in the drawings and the description to refer to the same or like parts.

In accordance with an exemplary embodiment, θ-alumina/hematite (θ-Al₂O₃/Fe₂O₃) composite nanofibers were synthesized via electrospinning followed by calcination and optimized towards heavy metal removal (for example, Cr(VI)). The composite nanofibers were characterized for their morphological and materials properties and tested in aqueous solutions containing chromate (CrO₄²⁻) to analyze their adsorption performance. Although, synthesized nanofibers have similar average diameter from, for example, 23 nm to 26 nm independent of the composition, Brunauer-Emmett-Teller (BET) analysis showed an increase in specific surface area with increasing Al content from 59.2 m²/g to 92.8 m²/g, which suggests the synergy of θ-Al₂O₃ and Fe₂O₃ causing increased surface roughness and greater porosity. In accordance with an exemplary embodiment, the CrO₄₋₂ adsorption capacity increased with increase in Al content. For example, θ-Al₂O₃/Fe₂O₃ nanofibers with 32 wt. % of Al have an adsorption capacity of 169.5 mg/g, which is twice the value of the pure Fe₂O₃ nanofibers and over a 3-fold increase compared to the commercial Fe₂O₃ nanoparticles. In accordance with an exemplary embodiment, the composite of hematite and θ-alumina demonstrated better physical properties (for example, larger surface area, smaller pore size, larger pore volume, etc.) and, in turn, enhanced adsorption removal of heavy metal pollutants

### Reagents

In accordance with an exemplary embodiment, all chemicals were reagent grade or better and used as received. The synthesis of the unmodified (0 at. % Al/Fe) Fe₂O₃ nanofibers involved iron(III) 2-ethylhexano-isopropoxide (Alfa Aesar, 10% w/v in isopropanol) as the iron precursor, acetic acid (Fisher Scientific, glacial 99.7%) as an additive and polyvinylpyrrolidone (PVP) (Sigma Aldrich, MW: 1,300,000 g/mol) as the polymer. The Al precursor used to fabricate θ-Al₂O₃/Fe₂O₃ composite nanofibers was aluminum oxide hydroxide (AlOOH) nanopowder, which was synthesized based on previous research (A. Mahapatra, B. G. Mishra, G. Hota, J. Hazard. Mater. 258-259, 116-123 (2013) (hereinafter “Mahapatra et al.”), and S.-M. Kim, Y.-J. Lee, K.-W. Jun, J.-Y. Park, H. S. Potdar, Mater. Chem. Phys. 104, 56-61 (2007) (hereinafter “Kim et al.) using aluminum isopropoxide (AIIP) (Sigma Aldrich, >98%), acetic acid, DI water and isopropanol (Fisher Scientific, Certified ACS Plus). Sorption experiments were conducted in solutions of 25 mM sodium chloride (NaCl) (Sigma Aldrich, >99.0%) and without any pH buffer, with all pH control attained through the addition of a diluted acid (HCl) or base (NaOH) to achieve and maintain the desired pH value. Similarly, a solution prepared from 10 mM NaCl was used in all zeta potential experiments. Lastly, potassium chromate (K₂CrO₄) (Fisher Scientific) was used as the heavy metal pollutant for the adsorption studies.

Synthesis of Al₂O₃—Fe₂O₃ Nanofibers

The synthesis of unmodified Fe₂O₃ nanofibers began with the preparation of the polymer solution. Based on previous work, (M. J. Nalbandian, M. Zhang, J. Sanchez, Y.-H. Choa, J. Nam, D. M. Cwiertny, N. V. Myung, Chemosphere 144, 975-981 (2016)), 3 mL of iron(III) 2-ethylhexano-isopropoxide, 0.3 mL acetic acid and 4 wt. % (0.125 g) of PVP were added in a 30 mL glass beaker and stirred with a magnetic stirrer at a rate of 300 rpm for an hour, insuring that all of the PVP has dissolved. For the composite nanofibers, a select amount of the AlOOH powder was added to the eletrospinning solution with anticipated content loading of 0, 10, 30, and 50 at. % Al to Fe. The total amount of metal precursor (Al and Fe) to the entire electrospinning solution was kept at 9 wt. %, just as the pure Fe₂O₃ nanofibers, in an effort to prevent any increase of average diameter due to the increase in metal content. In accordance with an exemplary embodiment, the AlOOH powder was synthesized by mixing 1 g of AIIP, 6 μL of acetic acid, 353 μL of DI water and 7.1 mL of isopropanol in a beaker for 6 hours until a well-mixed suspension was formed following the process previously presented by Kim et al. and later by Mahapatra et al. The AIIP sol-gel was then placed in an oven at 80° C. for 24 hours, forming the AlOOH powder.

In accordance with an exemplary embodiment, for the electrospinning set-up, the electrospinning solution was transferred into a plastic syringe with a metallic adapter and a 25 gauge needle (NanoNC; Korea) and loaded onto a syringe driver from New Era Pump Systems, Inc. (Farmingdale, N.Y.). The syringe was set at a distance of 10 cm from a rotating drum collector (SPG Co., Ltd.; Korea). The metallic adapter was also connected to an Acopian (Easton, Pa.) high voltage power supply. The feed rate of the syringe driver was set at 0.3 mL/hr and the applied voltage was set at 20 kV. After electrospinning, the unmodified Fe₂O₃ nanofibers were annealed at 500° C. at rate of 3° C./min and held for 3 hours, while the composite nanofibers were annealed at 1000° C. in order for both metal oxides to crystallize. After annealing, the nanofibers were kept as dry samples in 20 mL glass vials for characterization and were later used to make 1 g/L stock suspensions in DI water for zeta potential and adsorption tests.

### Nanofiber Characterization

The nanofibers were characterized using several different techniques to quantify their size, morphological and optical properties. Nanofiber diameter was examined by a Phillips XL30 FEG scanning electron microscopy (SEM). For SEM, samples were prepared by placing approximately a 0.5 cm×0.5 cm area of nanofibers onto a SEM sample holder. SEM imaging of n=40 nanofibers yielded average diameters (with standard deviation) that were used to create sizing histograms. Energy dispersive X-ray (EDX) analysis was conducted following SEM imaging for the θ-Al₂O₃/Fe₂O₃ nanofibers to quantify elemental composition.

In accordance with an exemplary embodiment, crystal phase, crystal orientation and average grain size were determined by a Bruker D8 Advance X-ray diffraction (XRD) analyzer. The 1×1 cm² samples were analyzed from 20° to 80° for the Bragg angle with an interval of 0.03°. Average grain size was quantified by means of the Scherrer-Debye equation, which relates grain size to the diffraction peak properties. In accordance with an exemplary embodiment, the prominent hematite peak (104) was used for this calculation.

Zeta potential was determined by a Brookhaven Instrumental Corporation ZetaPALS zeta potential analyzer. 100 μL of the 1 g/L nanofiber stock suspension was added to 3.5 mL of 10 mM NaCl set at various pH values between 2 and 9. The point of zero charge (pzc) was calculated by interpolation between data points in which a zeta potential equal to 0 was achieved.

Surface area was determined by BET analysis via Micromeritics ASAP 2020 Physisorption Analyzer in order to investigate any surface property change towards enhancement of adsorption. All samples were degassed at 300° C. for 3 hours prior to analysis. In addition to total surface area, mesoporous (2-50 nm) surface area and microporous (less than (<) 2 nm) surface area, pore diameter and pore volume were also provided.

### Adsorption Experiments

In accordance with an exemplary embodiment, adsorption tests were conducted to quantify the performance capabilities of the composite nanofibers. First, six individual 10 mL vials contained 25 mM NaCl solution at pH 6, 0.1 g/L nanofiber loading, and an initial CrO₄²⁻ concentration, which ranged from 5 μM to 200 μM. After the addition of the heavy metal anion to the reactor vial, an initial sample of 0.5 mL is immediately withdrawn and passed through a 0.2 μm PFTE filter to remove the suspended nanofibers. Afterwards, the reaction vials are set on a circular rotator and mixed for 2 hours to reach equilibrium. After 2 hours of agitation, a 0.5 mL aliquot from each reaction vial was withdrawn and filtered as the final sample. The dissolved concentrations of the heavy metal anions were determined via atomic absorbance spectrometer (AAS) (Perkin Elmer AAnalyst 800) with a flame atomizer and appropriate hollow cathode lamps for Cr. Prior to the adsorption experiments, a calibration curve was created to correlate the light absorbance from the AAS to the heavy metal anion concentration. The supernatant from the reaction vials was run through the flame and the light absorbance was recorded. Based on the difference between the light absorbance of the initial and final sample, the amount of the heavy metal anion adsorbed by the substrate was calculated. The adsorption isotherms were then fitted towards the Langmuir adsorption model, which is defined as:

$${q}_{e} = {q}_{m} \frac{{bc}_{e}}{1 + {bc}_{e}} \qquad ( 1 )$$

where cₑ is the equilibrium concentration of heavy metal anion in mg/L, qₑ is equilibrium adsorption capacity of the adsorption substrate in mg/g, qₘ is the maximum adsorption capacity in mg/g, and b is the Langmuir equilibrium constant in L/mg. The Langmuir linear regression fit was utilized to yield a maximum adsorption capacity:

$$\frac{{c}_{e}}{{q}_{e}} = \frac{1}{{bq}_{m}} + \frac{{c}_{e}}{{q}_{m}} \qquad ( 2 )$$

Additionally, in accordance with an exemplary embodiment, adsorption kinetics was analyzed by mixing a reaction vial, containing the NaCl solution, Fe₂O₃ nanofibers and an initial heavy metal anion concentration of 50 μM. 0.5 mL aliquots were withdrawn and filtered with respect to time (0 to 120 min). Samples were analyzed via AAS and adsorption kinetic rates were calculated by fitting the data into a pseudo-second-order adsorption kinetic model, described in the following equation.

$$\frac{{dq}_{t}}{dt} = {k ( {q}_{e} - {q}_{t} )}^{2} \qquad ( 3 )$$

where t is time in minutes, qₜ is the amount of heavy metal anion adsorbed at time t in mg/g, qₑ is equilibrium adsorption capacity in mg/g, and k is the second-order adsorption rate constant in g/mg·min. The value of kqₑ² can be defined as h, the initial adsorption rate in mg/g·min, and used to compare among the different nanofiber materials. After integrating equation 3 as a function of time, the integrated equation can be rearranged to obtain:

$$\frac{t}{{q}_{t}} = \frac{1}{{kq}_{e}^{2}} + \frac{1}{{q}_{e}} t \qquad ( 4 )$$

### Nanofiber Characterization

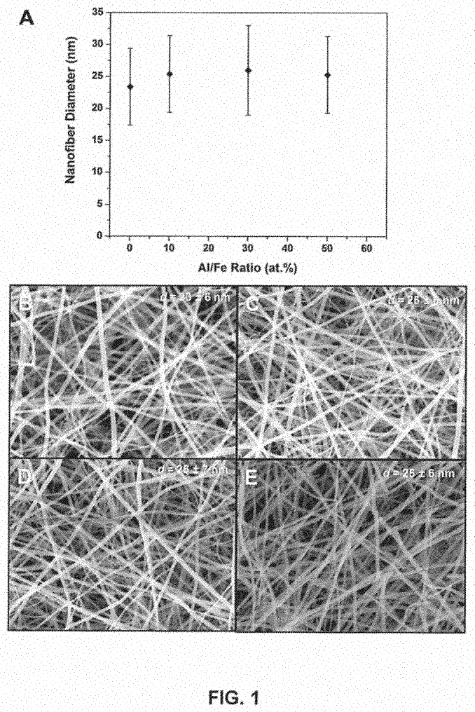

In accordance with an exemplary embodiment, θ-Al₂O₃/Fe₂O₃ composite nanofibers were synthesized using the protocol that yielded 23 nm-sized unmodified Fe₂O₃ nanofibers (4 wt. % PVP, 20 kV voltage, 0.3 mL/hr feed rate). Based on SEM analysis, there was no significant change in average diameter of the θ-Al₂O₃/Fe₂O₃ composite nanofibers. As seen in FIG. 1, the average diameter slightly increased from 23 (±6) nm to 25-26 (±6-7) nm with the addition of Al, but was still well within the standard error of the unmodified nanofibers.

EDX analysis was conducted to validate the presence of Al in the composite nanofibers. FIG. 6 provides the EDX spectra of the θ-Al₂O₃/Fe₂O₃ nanofibers, showing the growth of an Al peak with increasing Al content, although slightly lower than anticipated. In accordance with previous work (R. Li, Q. Li, S. Gao, J. K. Shang, J. Am. Ceram. Soc. 94, 584-591 (2011)), the atomic percent of oxygen (O) reached around approximately (˜) 60 at. % while the atomic percentage of Al and Fe together was approximately (˜) 40 at. % since the O atomic percent stayed stable at approximately (˜) 60 at. % with increased Al content, the species of Al oxide in the nanofibers is highly likely to be Al₂O₃. In accordance with an exemplary embodiment, based on EDX analysis, the Al to Fe ratio values for the composite nanofibers will be considered 9.7, 18.7, and 32.4 at. % (formerly 10, 30, and 50 at. %, respectively), while their Al content (Al/Al+Fe) will be 8.9, 15.8, and 24.4 at. %, respectively. Henceforth, the composite nanofiber material names were designated as 10, 19, and 32% Al/Fe.

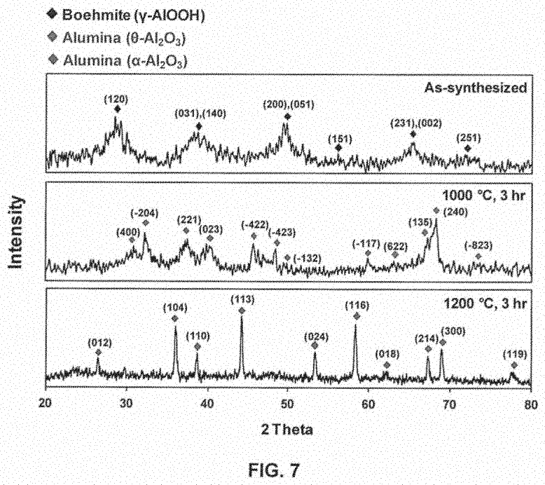

XRD characterization was conducted to analyze crystallinity and crystal phase of the composite nanofibers. Firstly, XRD analysis was carried out on the AlOOH nanopowder to verify its crystal structure. The XRD spectra, seen in FIG. 7, verified that the synthesized nanopowder was boehmite, γ-AlOOH (#21-1307) and, annealed at 1000 and 1200° C., the nanopowder transformed into θ-Al₂O₃ (#11-0517) and α-Al₂O₃ (#10-0173), respectively, in accordance to previous work (Mahapatra et al., and S. C. Lee, M. S. Cho, S. Y. Jung, C. K. Ryu, J. C. Kim, Adsorption 20, 331-339 (2013)), although their intensities were nearly 10-20% that of hematite.

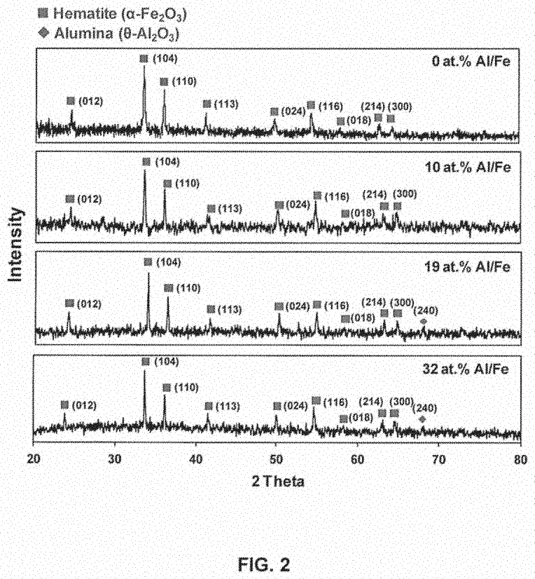

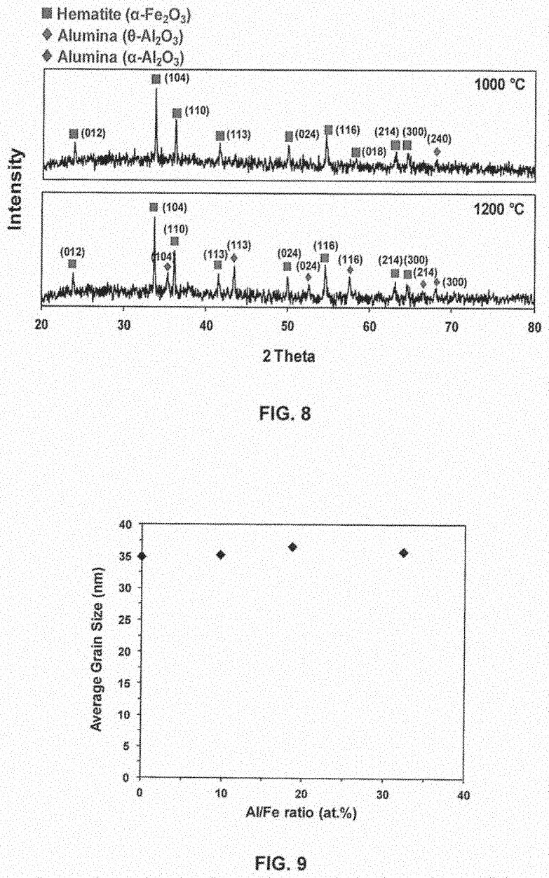

In accordance with an exemplary embodiment, as shown in FIG. 2, the θ-Al₂O₃/Fe₂O₃ nanofibers showed hematite pattern (#33-0664) for all samples and a very small (2 4 0) θ-Al₂O₃ peak for both 19 and 32% Al/Fe, possible due to the low intensity of the θ-Al₂O₃ spectra. Previous work has shown similar results, where no substantial Al peaks from XRD spectra were observed, even up to 50 mol % Al to Fe. The 32 at. % Al/Fe nanofiber sample annealed at 1200° C. maintained the hematite pattern and exhibited several α-Al₂O₃ peaks (FIG. 8). Additionally, there was no significant change in average grain size of the composite nanofibers despite the higher annealing temperature (FIG. 9), where the average grain size was stable at 35 nm regardless of the Al content. Similar to previous results, the average grain sizes were slightly larger than the nanofiber diameter, indicating possible ellipsoidal grains existing within the nanofibers.

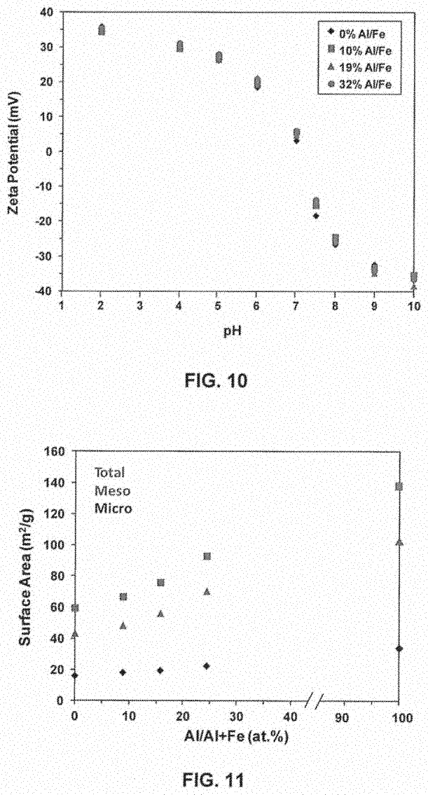

In accordance with an exemplary embodiment, zeta potential measurements of the composite nanofibers were conducted to observe any change in the surface charge of the θ-Al₂O₃/Fe₂O₃ nanofibers that could have occurred due to the addition of Al, possibly altering the potential of zero charge (pzc). As seen in FIG. 10, zeta potential did not show any significant shift with the addition of Al. The pH of pzc increased from 7.08 for the pure nanofibers to 7.13-7.15 for the composite nanofibers, still within the value of the commercially available Fe₂O₃ nanoparticles (7.12) and comparable to reported values.

In accordance with an exemplary embodiment, BET analysis provided information on specific surface area and pore dimension of the θ-Al₂O₃/Fe₂O₃ composite nanofibers (Table 1). Specific surface area increased with increased Al/Fe ratio, indicating enhanced surface area due to the introduction of Al (FIG. 11). The specific surface area increased from 59.2 m²/g for the unmodified Fe₂O₃ nanofibers up to 92.8 m²/g for the 32 at. % Al/Fe composite nanofibers. These results correlate with previous research, where Al incorporation has a significant effect on enhancing specific surface area. In accordance with an exemplary embodiment, the high surface area of the Al₂O₃ nanopowder (137.3 m²/g) contributed to the overall enhanced surface area of the composite nanofibers. Additionally, pore volume increased and average pore width decreased alongside increased Al/Fe ratio, which correlates with increased surface area. The static contribution of mesopores and micropores with increased Al content (˜75% and ˜25%, respectively) indicates a dominance of smaller sized (closer to 2 nm) mesopores for the composite nanofibers. Furthermore, the surface area of the composite nanofibers was greater than the calculated surface area from the sum of the specific metal oxide contributions according to XRD and BET data, which suggests synergy between the Fe₂O₃ and θ-Al₂O₃ to yield increased porosity and enhanced surface area. In accordance with an exemplary embodiment, it is likely that the difference in average grain size of the Fe₂O₃ (approximately (˜) 35 nm) and θ-Al₂O₃ (˜15 nm) within the nanofiber led to increased surface roughness, thus promoting greater porosity and larger surface area. Comparatively, in accordance with an exemplary embodiment, the composite nanofibers had significantly greater surface area than the commercially available Fe₂O₃ nanoparticles (28.4 m²/g).

TABLE 1
BET analysis data of commercially-available Fe₂O₃
nanoparticles, unmodified Fe₂O₃ nanofibers, Al₂O₃/Fe₂O₃ composite nanofibers,
and synthesized Al₂O₃ nanoparticles

| | | | | BET Analysis | | | | |
|---|---|---|---|---|---|---|---|---|
| Material | | | | | | | Pore | Average |
| | Al/Fe ratio | Al/Al + Fe | Crystal | SSA | SSA_{Meso} | SSA_{Micro} | Volume | Pore Width |
| Structure | (at. %) | (at. %) | Phase | (m²/g) | (m²/g) | (m²/g) | (cm³/g) | (nm) |
| Fe₂O₃ NPs | 0 | 0 | α (Fe) | 28.4 | 22.5 | 5.9 | 0.094 | 13.2 |
| Al₂O₃—Fe₂O₃ NFs | 0 | 0 | α (Fe) | 59.2 | 43.2 | 16.0 | 0.198 | 13.4 |
| | 9.7 | 8.9 | α (Fe), θ (Al) | 66.4 | 48.3 | 18.1 | 0.201 | 12.1 |
| | 18.7 | 15.8 | α (Fe), θ (Al) | 75.6 | 56.1 | 19.5 | 0.206 | 10.9 |
| | 32.4 | 24.4 | α (Fe), θ (Al) | 92.8 | 70.3 | 22.5 | 0.217 | 9.3 |
| | 32.4 | 24.4 | α (Fe), θ (Al) | 53.2 | 35.0 | 18.2 | 0.115 | 8.6 |
| Al₂O₃ NPs | — | 100 | θ (Al) | 137.3 | 102.8 | 34.5 | 0.791 | 23.0 |
| | — | 100 | α (Al) | 10.4 | 1.8 | 9.1 | 0.018 | 6.7 |

Moreover, the BET analysis of the 32 at. % Al/Fe nanofibers provides more evidence of Al's strong influence on the surface area of the composite nanofibers. Annealed at a higher temperature of 1200° C., the surface area of the 32 at. % composite nanofibers decreased significantly (53.3 m²/g), most likely due to the phase transformation from θ-Al₂O₃ to α-Al₂O₃ (10.9 m²/g). Similar to the other composite nanofibers, the surface area was greater than the calculated contributions, which could be due to the change different in grain size between the Fe₂O₃ and α-Al₂O₃ (˜25 nm). However, the low surface area of the α-Al₂O₃ led to a considerable decrease in surface area of the α-alumina-containing composite nanofibers, which could be detrimental to adsorption performance.

### Adsorption Performance

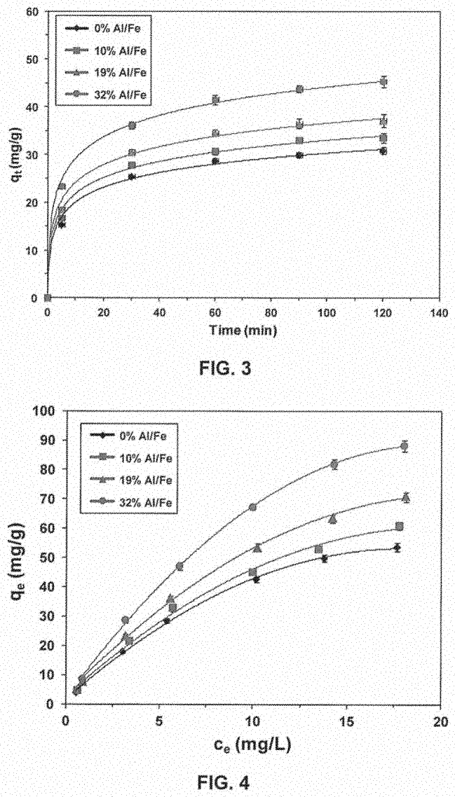

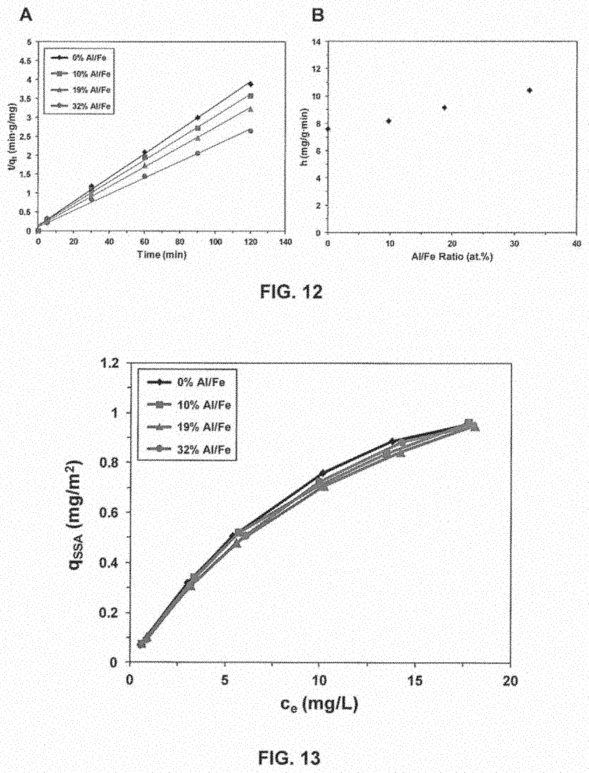

Adsorption kinetics was determined to identify the rate of CrO₄²⁻ adsorption on the θ-Al₂O₃/Fe₂O₃ composite nanofibers. The adsorption of CrO₄²⁻ (C₀=50 μM) on the composite nanofibers with respect to time can be seen in FIG. 3. Adsorption was initially rapid up to 30 minutes and plateaued gradually afterwards as adsorption reaches equilibrium. Plotting t/qₜ as a function of time, as seen in FIG. 12A, will linearize the pseudo-second order kinetic model to yield initial adsorption rate, h. Initial adsorption rate of the composite nanofibers increased with increased Al content (FIG. 12B). The increased surface area brought upon by the introduction of Al in the composite nanofibers led to increased adsorption kinetics.

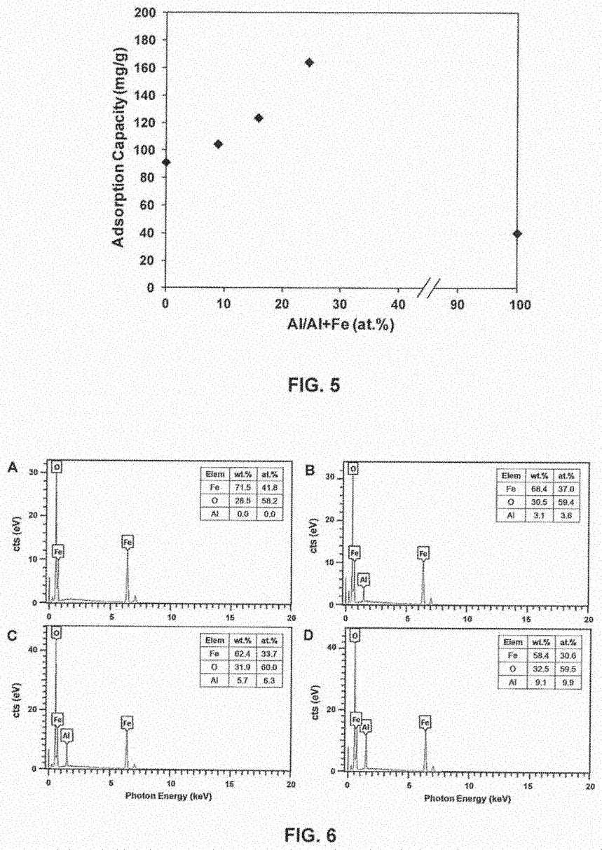

Moreover, adsorption isotherms helped quantify the CrO₄²⁻ adsorption capacity of the composite nanofibers. FIG. 4 shows that the increasing Al content leads to greater adsorption according to the isotherm curves, which is expected due to the Al's contribution to surface area. Furthermore, the adsorption isotherm curves normalized by specific surface area showed uniformity at all Al/Fe ratios (FIG. 13), which indicates that adsorption performance is significantly linked to specific surface area. As seen in FIG. 5, the adsorption capacity increased dramatically due to Al introduction, where the maximum adsorption capacity value increased from 90.9 mg/g for the unmodified Fe₂O₃ nanofibers to 163.9 mg/g for the 32 at. % Al/Fe composite nanofibers.

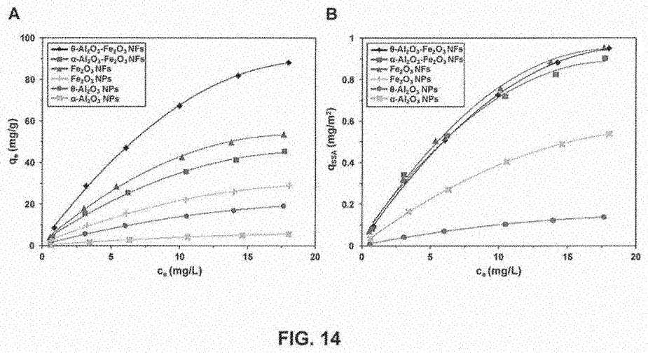

Adsorption isotherms in FIG. 14A show the performance of the 32 at. % Al/Fe composite nanofibers, as well as the Al₂O₃ nanopowders, as a function of alumina phase. The α-Al₂O₃/Fe₂O₃ composite nanofibers (77.5 mg/g) performed worse than the θ-Al₂O₃/Fe₂O₃ composite (163.9 mg/g) and unmodified nanofibers (90.9 mg/g) on a mass basis, but all performed similarly when normalized by surface area, which again suggests surface area-driven adsorption. Similarly, α-Al₂O₃ nanoparticles (11.7 mg/g) was outperformed by θ-Al₂O₃ (39.7 mg/g) nanoparticles, but was significantly more efficient on a surface area-basis (FIG. 14B), which suggests that the θ-Al₂O₃ nanoparticles in the composite nanofibers, regardless of crystal phase, provide their distinctively qualities to enhance surface area substantially, but not adsorption capabilities. In summary, as seen in Error! Reference source not found., adsorption capacity (qₘ) and kinetics (h) were improved with the addition of θ-Al₂O₃ in the composite nanofibers, and based on the performance of the unmodified Fe₂O₃ nanofibers and the synthesized Al₂O₃ nanoparticles, there is likely synergy existing between the θ-Al₂O₃ and Fe₂O₃ towards enhanced adsorption performance.

TABLE 2
Adsorption performance parameters of commercially-
available Fe₂O₃ nanoparticles, unmodified Fe₂O₃ nanofibers, Al₂O₃/Fe₂O₃
composite nanofibers, and synthesized Al₂O₃ nanoparticles.

| Material | | | | Sorption Isotherm | | | Sorption Kinetics | | |
|---|---|---|---|---|---|---|---|---|---|
| | Al/Fe ratio | Al/Al + Fe | Crystal | qₘ | b | | k | h | |
| Structure | (%) | (at. %) | Phase | (mg/g) | (L/mg) | R² | (g/mg · min) | (mg/g · min) | R² |
| Fe₂O₃ NPs | 0 | 0 | α (Fe) | 49.2 | 0.078 | 0.998 | 0.0178 | 3.73 | 0.998 |
| Al₂O₃—Fe₂O₃ NFs | 0 | 0 | α (Fe) | 90.9 | 0.080 | 0.997 | 0.0077 | 7.59 | 0.995 |
| | 9.7 | 8.9 | α (Fe), θ (Al) | 104.2 | 0.078 | 0.998 | 0.0069 | 8.18 | 0.995 |
| | 18.7 | 15.8 | α (Fe), θ (Al) | 123.5 | 0.075 | 0.999 | 0.0063 | 9.16 | 0.995 |
| | 32.4 | 24.4 | α (Fe), θ (Al) | 163.9 | 0.073 | 0.993 | 0.0049 | 10.42 | 0.998 |
| | 32.4 | 24.4 | α (Fe), θ (Al) | 77.5 | 0.075 | 0.999 | 0.0077 | 5.60 | 0.991 |
| Al₂O₃ NPs | — | 100 | θ (Al) | 39.7 | 0.053 | 0.997 | 0.0115 | 2.66 | 0.989 |
| | — | 100 | α (Al) | 11.7 | 0.052 | 0.995 | 0.0321 | 1.35 | 0.995 |

Overall, in accordance with an exemplary embodiment, the θ-Al₂O₃/Fe₂O₃ composite nanofibers exhibited enhanced adsorption of CrO₄²⁻ solely due to increased surface area. While the average diameter of the composite nanofibers was stable and independent of Al content, the increase in surface area can be exclusively attributed to the introduction of θ-Al₂O₃. Since the analyzed BET surface area was greater than the sum of the metal oxide contributions, the combination of Fe₂O₃ and θ-Al₂O₃ augmented surface area synergistically. In accordance with an exemplary embodiment, reports suggest that increased Al content in the composite nanofibers will increase the specific surface area via increased and retainable adsorption sites (—OH). Additionally, as previously stated, the differences in average grain size between θ-Al₂O₃ and Fe₂O₃ could introduce increased surface roughness, and subsequently, increased surface area. The isotherm studies revealed that adsorption capacity of the composite nanofibers increased due to the addition of Al, and that the performance was directly related to surface area based on the normalized isotherms. Since the adsorption performance of Fe₂O₃ was greater than that of θ-Al₂O₃, in accordance with an exemplary embodiment, the combination of θ-Al₂O₃ and Fe₂O₃ in the composite nanofibers provides enhanced adsorption of chromate synergistically. As previously stated, reports state that Fe₂O₃ is a better adsorbent than θ-Al₂O₃ due to stronger adsorption bonds, formed between the active sorption site on the adsorbent surface and the anionic heavy metal ligand due to ligand exchange. This finding is in accordance with this work's adsorption isotherm data, as the calculated Langmuir constant b, which is directly related to adsorption bond strength, was greater for the pure Fe₂O₃ (0.080 mg/L) than that of the pure θ-Al₂O₃ (0.053 L/mg).

In accordance with an exemplary embodiment, for the composite nanofibers, the Langmuir constants of the composite nanofibers decreased steadily with Al content; analysis of the Langmuir constants based on metal oxide composition suggests that the adsorption bond strength of both θ-Al₂O₃ and Fe₂O₃ was not altered within the composite nanofibers. Thus, the number of adsorption sites, not the strength of the adsorption bonds, on the composite nanofibers must have increased, resulting in greater adsorption capacity in relation to increased surface area. Additionally, considering that Fe content does decrease when adding more Al, the inclusion of Al in the composite nanofibers successfully yielded greater adsorption surface sites with less available Fe. Furthermore, since the Langmuir constant of the composite nanofibers steadily decreased towards the value of the Al₂O₃ nanoparticles, it is likely that further addition of Al content could disrupt or reduce the reactive adsorption sites of Fe₂O₃ surface and disturb the adsorption performance, indicating an optimal θ-Al₂O₃/Fe₂O₃ composition.

In accordance with an exemplary embodiment, electrospun θ-Al₂O₃/Fe₂O₃ composite nanofibers were fabricated to further enhance CrO₄²⁻ removal of conventional Fe₂O₃ nanomaterials. Through facile property modifications via electrospinning parameter tuning, composite nanofibers allows for control of nanofiber property manipulation towards optimization of CrO₄²⁻ adsorption. θ-Al₂O₃/Fe₂O₃ nanofibers were developed with controlled average diameter (˜25 nm), crystallinity (hematite), and average grain size (˜35 nm). Additionally, band gap and zeta potential were unaltered with the addition of Al. However, specific surface area of the composite nanofiber was greatly enhanced due to the addition of Al, increasing surface area value with increased Al content. As a result, adsorption capacity and kinetics were enhanced based on adsorption studies with CrO₄²⁻. With a specific surface area of 92.8 m²/g, the 32 at. % Al/Fe composite nanofibers had outperformed the unmodified Fe₂O₃ nanofibers by nearly a factor of 2 and the commercially available Fe₂O₃ nanoparticles by over a factor of 3. Based on the adsorption studies, synergy between Al₂O₃ and Fe₂O₃ resulting in increased porosity, and thus increased surface adsorption sites, led to greater adsorption performance.

In accordance with an exemplary embodiment, the composite θ-Al₂O₃/Fe₂O₃ nanofibers represent innovative nanomaterials for future treatment systems, having greater pollutant removal and greater potential for implementation into existing treatment methods than conventional materials used in remediation of heavy metal-containing water sources.

It will be apparent to those skilled in the art that various modifications and variation can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A method of synthesizing θ-alumina/hematite (θ-Al₂O₃/Fe₂O₃) composite nanofibers, the method comprising:
preparing a polymer solution, the polymer solution comprising an iron precursor, acetic acid and a polymer;
adding a select amount of an aluminum precursor to the polymer solution; and
electrospinning the polymer solution and the select amount of the aluminum precursor to form the θ-Al₂O₃/Fe₂O₃ composite nanofibers.

2. The method of claim 1, wherein the iron precursor is iron(III) 2-ethylhexano-isopropoxide and the polymer is polyvinylpyrrolidone (PVP).

3. The method of claim 1, wherein the aluminum precursor is an aluminum oxide hydroxide (AlOOH) nanopowder.

4. The method of claim 3, wherein the aluminum hydroxide (AlOOH) nanopowder is synthesized using aluminum isopropoxide (AIIP), acetic acid, DI water and isopropanol.

5. The method of claim 1, comprising:
maintaining a total amount of a metal precursor of Al and Fe to the polymer solution at 9 wt. %.

6. The method of claim 1, further comprising:
annealing the θ-Al₂O₃/Fe₂O₃ composite nanofibers.

7. The method of claim 1, further comprising:
synthesizing the θ-Al₂O₃/Fe₂O₃ composite nanofibers to an average diameter of 17 nm to 33 nm.

8. The method of claim 1, further comprising:
removing heavy metals from water with the θ-Al₂O₃/Fe₂O₃ composite nanofibers.

9. The method of claim 8, wherein the heavy metals include arsenic (As), chromium (Cr), cadmium (Cd), lead (Pb), copper (Cu), and cobalt (Co).

10. The method of claim 1, further comprising:
optimizing the θ-Al₂O₃/Fe₂O₃ composite nanofibers for CrO₄²⁻ adsorption by controlling an average diameter, crystallinity, and an average grain size of the θ-Al₂O₃/Fe₂O₃ composite nanofibers.

11. The method of claim 10, wherein the average diameter is approximately 25 nm, the crystallinity is hematite, and the average grain size is approximately 35 nm.

12. A method of removing heavy metals from water, the method comprising:
exposing a water source having at least one heavy metals to θ-Al₂O₃/Fe₂O₃ composite nanofibers.

13. The method of claim 12, wherein the θ-Al₂O₃/Fe₂O₃ composite nanofibers are synthesized θ-alumina/hematite (θ-Al₂O₃/Fe₂O₃) composite nanofibers.

14. The method of claim 13, further comprising:
synthesizing the synthesized θ-Al₂O₃/Fe₂O₃ composite nanofibers by:
preparing a polymer solution, the polymer solution comprising an iron precursor, acetic acid and a polymer;
adding a select amount of an aluminum precursor to the polymer solution; and
electrospinning the polymer solution and the select amount of the aluminum precursor to form the θ-Al₂O₃/Fe₂O₃ composite nanofibers.

15. The method of claim 14, wherein the iron precursor is iron(III) 2-ethylhexano-isopropoxide and the polymer is polyvinylpyrrolidone (PVP).

16. The method of claim 14, wherein the aluminum precursor is an aluminum oxide hydroxide (AlOOH) nanopowder.

17. The method of claim 16, wherein the aluminum hydroxide (AlOOH) nanopowder is synthesized using aluminum isopropoxide (AIIP), acetic acid, DI water and isopropanol.

18. The method of claim 14, comprising:
maintaining a total amount of a metal precursor of Al and Fe to the polymer solution at 9 wt. %.

19. The method of claim 14, further comprising:
annealing the θ-Al₂O₃/Fe₂O₃ composite nanofibers.

20. The method of claim 14, further comprising:
synthesizing the θ-Al₂O₃/Fe₂O₃ composite nanofibers to an average diameter of 17 nm to 33 nm.

21. The method of claim 12, wherein the at least one heavy metal includes arsenic (As), chromium (Cr), cadmium (Cd), lead (Pb), copper (Cu), and/or cobalt (Co).

22. The method of claim 12, further comprising:
optimizing the θ-Al₂O₃/Fe₂O₃ composite nanofibers for CrO₄²⁻ adsorption by controlling an average diameter, crystallinity, and an average grain size of the θ-Al₂O₃/Fe₂O₃ composite nanofibers.

23. The method of claim 22, wherein the average diameter is approximately 25 nm, the crystallinity is hematite, and the average grain size is approximately 35 nm.

24. A system for removing heavy metals from a water source, the system comprising:
θ-Al₂O₃/Fe₂O₃ composite nanofibers.

25. The system of claim 24, wherein the θ-Al₂O₃/Fe₂O₃ composite nanofibers are synthesized θ-alumina/hematite (θ-Al₂O₃/Fe₂O₃) composite nanofibers.

26. The system of claim 25, wherein the synthesized θ-Al₂O₃/Fe₂O₃ composite nanofibers comprise:
a polymer solution, the polymer solution comprising an iron precursor, acetic acid and a polymer; and
a select amount of an aluminum precursor added to the polymer solution, and electrospinning the polymer solution and the select amount of the aluminum precursor to form the θ-Al₂O₃/Fe₂O₃ composite nanofibers.

27. The system of claim 26, wherein the iron precursor is iron(III) 2-ethylhexano-isopropoxide and the polymer is polyvinylpyrrolidone (PVP).

28. The system of claim 26, wherein the aluminum precursor is an aluminum oxide hydroxide (AlOOH) nanopowder.

29. The system of claim 28, wherein the aluminum hydroxide (AlOOH) nanopowder is synthesized using aluminum isopropoxide (AIIP), acetic acid, DI water and isopropanol.

30. The system of claim 24, wherein the heavy metal includes arsenic (As), chromium (Cr), cadmium (Cd), lead (Pb), copper (Cu), and/or cobalt (Co).
